(19) United States
(12) Patent Application Publication
(10) Pub. No.: US 2017/0069408 A1
(43) Pub. Date: Mar. 9, 2017

(54) FLAME RETARDANT CABLE FILLERS AND CABLES

(71) Applicant: WEB INDUSTRIES, INC., Marlborough, MA (US)

(72) Inventor: John P. Gagnon, Franklin, MA (US)

(21) Appl. No.: 15/354,727

(22) Filed: Nov. 17, 2016

Related U.S. Application Data
(62) Division of application No. 13/232,542, filed on Sep. 14, 2011, now abandoned.
(60) Provisional application No. 61/383,328, filed on Sep. 15, 2010.

(51) Int. Cl. H01B 7/295; C08K 5/3492; C08K 5/3435; H01B 3/44; G02B 6/44

(52) U.S. Cl. CPC H01B 7/295; H01B 3/441; G02B 6/4436; C08K 5/3435; C08K 5/3492

(57) ABSTRACT

Flame retardant fiber optic and electrically conductive cables having halogen-free flame retardant cable filler materials.

### RELATED APPLICATION

The present application is a divisional application of U.S. patent application Ser. No. 13/232,542 filed on Sep. 14, 2011 which claims the benefit of U.S. Provisional Patent Application No. 61/383,328 filed on Sep. 15, 2010 and entitled “Flame Retardant Cable Fillers and Cables,” the contents of which are hereby incorporated herein in their entirety.

### FIELD OF THE INVENTION

The present teaching relates to zero halogen releasing, self-extinguishing, flame retardant cable filler materials as well as electric cables and, telecommunication cables comprising the same. In particular, the present teaching relates to such flame retardant cable fillers wherein the cable fillers comprise a foamed and/or fibrillated polymer material in fiber or strip form, especially those composed of foamed polyolefins, especially foamed polypropylene.

### BACKGROUND

Conductive cables have many applications, from power transmission to electric data transmission, including audio and video data. Traditional cables comprise three key elements: one or more conductors, insulation to maintain electrical continuity or signal integrity and a sheath or protective jacket. The makeup and construction of individual cables varies depending upon the end-use application of the cable. Materials selection is determined by several factors, four of which are: (1) the working voltage of the electrical energy passing through the conductor, which determines the thickness of the insulation; (2) the intended current capacity, which determines the diameter of the conductor; (3) the environmental conditions to which the cable will be exposed, especially temperature, water/humidity, chemical and sunlight exposures, as well as whether the cables will be buried or not; and (4) fire and/or flammability resistance, especially industrial and/or governmental imposed code regulations pertaining to flammability, self-extinguishing characteristics, smoke generation and the like. Similarly, the construction of individual cables is determined, in part, by its end-use application and how it is to be used, e.g., whether the cable needs flexibility or not, whether EMI/RFI shielding is an issue, and the like. Various cable constructions include those wherein the conductors are in the form of a solid wire or strands of thinner wires; twisted pair cabling wherein two conductors are twisted around one another, including foiled twisted pairs, shielded twisted pairs, and unshielded twisted pairs; coaxial cables wherein an inner conductor is surrounded by a flexible, tubular insulating layer which, in turn, is surrounded by a tubular conducting layer or shield, which is then encased in a protective sheath.

Although most conductive wire used in cable construction is coated with a polymer material, which provides some measure of insulation to that wire, cables themselves can employ an individual cable filler material which adds further insulating properties to the cable construction while also serving, in conjunction with the cable sheath or protective jacket, to essentially “fix” the individual conductive wires in place within the protective sheath while allowing flexibility of and movement within the cable as the cable is being wound, flexed, installed, etc. Cable fillers are made of a number of different materials and come in a variety of different forms, and configurations, again depending upon the end-use application. Such materials include natural and synthetic materials, including, paper, glass, and, most especially, plastics/polymers such as PVC, polyester, perfluoro and fluoropolymers, e.g. FEP, MFA, PFA, ECTFE, PVDF, and polyolefins. These materials may be used in curable/cross-linkable granular or powder form or they may be preformed into a number of forms such as fibers and monofilaments, fibrillated and non-fibrillated tapes (including slit and single end) and yarns, braided yarns, cross-webs, and the like: the later being in a foamed or non-foamed state. Additionally, the cable fillers may be hybrid materials such as PTFE coated fiberglass cordage. Perhaps the most common insulating fillers are yarns, flat (untwisted) fibrillated fillers (an extruded plastic tape that is mechanically fibrillated to impart a mesh pattern to the filler to soften it and allow it to uniformly fill the vacant spaces between the conductors and within the protective jacket), and twisted plastic fillers (an extruded plastic tape that is twisted to form a round length).

Other types of cable filler, which may be used alone or in combination with the insulating type cable fillers mentioned above, are those known in the art as cable filling compounds. These typically comprise hydrocarbon greases, waxes and oils such as petrolatum, petrolatum/olefin waxes, paraffin waxes and oils, naphthenic oils, mineral oils, oil modified rubbers, etc., especially petroleum jelly and other similar, especially dielectric jellies and greases

There are many industry and governmental codes and regulations pertaining to electrical conducting cable construction and performance, especially for different end-use applications. Of particular import are those associated with flame resistance, flame propagation, and smoke emissions. To date, these concerns are frequently dealt with by the use of polymer having inherent flame retardant characteristics, most notably as a result of the presence of halogen atoms in the polymer structure, for example fluorinated, chlorinated and brominated polymers, such as PVC, PVDF, FEP, PTFE, and the like, or by the addition or incorporation of flame retardant additives, especially organohalogen compounds, halogenated and non-halogenated phosphorous compounds, metal oxides, metal hydrates, and the like. Although the latter typically refers to the addition of an additive compound, it is to be appreciated that this also pertains to blends of the virgin or non-halogenated polymers with their halogenated equivalent or an otherwise compatible halogenated polymer. Where a halogenated flame retardant is to be employed in combination with the polymeric cable filler material, especially when used in further combination with a cable filling compound, the flame retardant additive is merely added to the mixture and not incorporated into the polymer itself. This is especially true in those circumstances where the form of the cable insulating filler must undergo significant processing and/or require retention of certain physical properties such as tensile strength and elongation since such additives typically make the processing thereof, e.g., in making yams and strips, especially foamed and/or fibrillated versions thereof, very difficult, if not impossible and adversely affect the physical properties thereof.

While each of these has proven beneficial in reducing the flammability, flame propagation, smoke emissions and/or polymer drip associated with such materials when exposed to fire, each comes with various detrimental aspects as well. For example, the halogenated materials, especially the brominated compounds, are designed to release or generate halogenated gases which can be both corrosive (acid gases) as well as toxic. This is due to the functional mode that this design utilizes for fire resistance. This involves the displacement of oxygen by the toxic halogenated gases which, in turn, reduce the survivability of persons caught in the fire. Indeed, certain organobrominated compounds have come under significant governmental scrutiny for their generation of toxic gases and/or byproducts, including carcinogens and suspected carcinogens such as dioxanes in the case of polybrominated diphenylene oxides. Similarly, the metal hydrates and metal oxides present a number of exposure and toxicity issues in relation to their heavy metal component. The use of these materials has also been associated with significant smoke generation during a fire. Thus, while the classic flame retardants (“FRs”) may be effective combustion suppressants, the toxic gases and smoke they form pose a significant human exposure threat.

A new generation of flame retardant additives have been identified which are free of halogens and heavy metals, but have limited application on their own and manifest their best performance when used in combination with traditional FRs. Specifically, Horsey et. al. (U.S. Pat. No. 6,472,456; U.S. Pat. No. 6,599,963 and U.S. Pat. No. 6,800,678) found that certain hindered amines, which they identified as NOR or NOROL hindered amines, previously known for their light and/or thermal stabilization properties in a host of organic materials, especially polymer materials and compositions, manifested flame retardant properties as well. Though these hindered amines were said to manifest flame retardant properties on their own, Horsey et. al. found that the performance is most noted when used in combination with traditional FRs, especially halogenated flame retardants. Furthermore, whether on their own or in a synergistic combination with traditional FRs, the efficacy of the flame retardant properties was markedly affected by the specific polymer into which they were incorporated as well as the physical form of that polymer. Indeed, Horsey et. al. found a marked variability in flame retardant properties from one polymer to another and, most critically, from one physical form of a given polymer to another. Such differences were found regardless of whether the NOR and NOROL hindered amines were used on their own or when used in combination with traditional FRs: combinations that Horsey et. al. found to be synergistic. The extent of variability was so great that several of the tested compositions and forms of the flame retardant compositions failed to pass or meet certain standard flame retardant tests. Such was particularly evident in those examples wherein the substrate was in the form of a thin film.

As noted, while Horsey et. al. demonstrated the utility and efficacy of the NOR and NOROL hindered amines as flame retardants and/or flame retardant synergists, they also demonstrated the unpredictability of FRs in general, as well as of their claimed NOR and NOROL hindered amines, with and without traditional FRs, especially as one transitioned from one polymer to another and from one physical form of the polymer to another. As evident from Horsey et. al., these compositions are especially useful then the flame retardant polymer is in a molded or thicker form. As also shown by Horsey et. al., these materials have found use in coatings for conductive wires as well as in sheathings or protective jackets for cable. However, despite their use these materials have not found utility in insulating cable filler materials, especially not foamed and/or fibrillated cable filler materials in the form of yarns and/or strips. Such is not unexpected since, as noted by Horsey et. al. these flame retardants, even in their synergistic combination, are found to be poorly efficacious or suited, if not non-efficacious and unsuitable, in thin films and strips: forms that are employed in cable filler applications.

Furthermore, owing to the known detrimental impact of such additives on the processing and physical properties of many polymer species, it is not unexpected that these materials would also have a significant adverse effect on the foaming ability and processing of the filler materials, especially in the fibrillation thereof, as well as on the physical properties thereof. Similarly, in light of the findings of Horsey et. al., it is not unexpected that these applications would have poor flame retardant characteristics, especially given the nature of fibrillated materials. Specifically, these materials have a high oxygen content and surface area facilitating flammability, low structural integrity whereby insufficient char is formed on the filler material to help extinguish any flame, etc.

Consequently, while industry has been able to employ the NOR and NOROL hindered amine flame retardants as coatings for conductive wires and in the sheathings or protective jackets of cables, they have not been able to eliminate the halogenated flame retardants altogether. And, since the cable fillers still require the presence of halogenated and/or heavy metal flame retardant materials, and since the combination of the NOR and NOROL hindered amines with traditional FRs provide a synergy in flame retardancy, industry has tended to employ these synergistic combinations in the conductive wire coatings and in the cable sheathing or protective jackets. However, it is appreciated that the amount of halogen and/or heavy metal is greatly reduced as compared to those applications where no NOR or NOROL hindered amine is present.

Thus, there remains a need and desire for halogen-free cable filler materials, especially those in the form of yarns and/or strips, most especially those that are foamed and/or fibrillated. In particular, there is a continuing need and desire for such materials where processability and physical properties are not compromised and current standards for flammability, flame resistance, smoke generation, etc. are met, if not exceeded.

### SUMMARY

It has now been found that the NOR and NOROL hindered amines, alone or in combination with other non-halogenated flame retardants, especially phosphorous flame retardants, when employed in limited concentrations are suitable and efficacious when used as flame retardant additives for polymers, especially polyolefins, used in the preparation of cable fillers in the form of strips, tapes, yarns, webs, filaments, fibers, rods, and the like, especially those which are foamed and/or fibrillated.

Specifically, surprisingly it has now been found that halogen-free flame retardant polyolefin cable fillers in the form of fibers, filaments, yarns, tapes and strips, especially those in the form of foamed and/or fibrillated yarns and strips, can be prepared and that such flame retardant cable fillers have low smoke emissions, high limited oxygen indices, low acid gas generation and good self extinguishing characteristics with minimal, if any detrimental impact on physical properties and/or processability. In particular, it has now been found that flame retardant polyolefin cable fillers may be prepared which have the attributes set forth in the Table 1 in combination with good processability and, especially when the cable is designed to enhance char support, good and stable char formation.

TABLE 1

| Attribute | Performance | Test Protocol |
|---|---|---|
| Limited Oxygen Index | 20 or higher, preferably | ASTM D2863 |
| | 25 or higher | |
| Acid Gas | 2% or less, preferably 1% | Mil-Spec 24643 |
| | or less | |
| Smoke Density | 30% or less, preferably | ASTM D2843 |
| | 20% or less | |
| Burn Duration | Less than 20 seconds, | ASTM D2863 |
| | preferably less than 15 | |
| | seconds | |

Cable fillers according the to present teachings are prepared from flame retardant polyolefins comprising from about 0.5 to about 5 wt %, preferably from about 1 to about 2.5 wt % of an NOR or NOROL hindered amine flame retardant, based on the combined weight of the hindered amine flame retardant and the polyolefin. Most preferably the cable fillers are prepared from flame retardant polyolefins comprising a) from about 10 to less than 30, preferably from about 15 to about 25 wt % of a halogen free phosphorous flame retardant, and b) from about 0.5 to about 5 wt %, preferably from about 1 to about 2 wt % of an NOR or NOROL hindered amine flame retardant, based on the combined weight of the flame retardant additives and the polyolefin.

Most especially, the cable fillers are comprised of foamed versions of the foregoing compositions, particularly those wherein the foaming is a result of the use of chemical foaming agents. In this latter respect, surprisingly, it has now been found that the combination of the flame retardant additives also results in a higher degree of foaming per unit of chemical foaming agent. Specifically, one is able to use less, generally at least 30% less, most often from 40 to 80% less, more typically from 50 to 70% less, chemical foaming agent, to achieve the same degree of density modification as attained without the flame retardant additives, especially the phosphorous flame retardant.

The foregoing flame retardant polyolefin compositions from which the cable fillers are prepared may further comprise traditional amounts of conventional polymer additives including colorants, stabilizers and the like. These halogen free cable fillers are prepared in accordance with known processes for their production: the difference being the presence of the aforementioned flame retardant or flame retardant combination.

In accordance with yet another aspect of the present teaching, there are provided flame retardant, electrically conductive cables wherein the cable filler is a halogen free, flame retardant polyolefin or foamed polyolefin in the form of a fiber, filament, yarn, tape, strip or web, which may also be fibrillated. Most preferably, the flame retardant cables produced according to the present teaching comprise elements, all of which are made of non-flammable materials or materials that have been rendered flame retardant, wherein the flame retardant additives are all halogen free and, most preferably, are free of heavy metals like antimony, etc.

### DETAILED DESCRIPTION

As used herein and in the appended claims, the term “halogen free” refers to the use of flame retardant additives and synergists which are free of or do not contain halogen atoms. Thus, while the preferred compositions employed in the practice of the present teaching are preferably free of halogen atoms and halogen atom containing constituents as a whole, it is possible that some halogen may be present in the composition, but not owing to the flame retardant additive(s). This does not mean that other constituents in the composition are halogen free, as such may be present but: though certainly not preferred and, in this respect, it is most preferred that the compositions from which the cable fillers are made are essentially halogen free and, in any event do not contain halogenated flame retardants in a flame retardant amount. Additionally, the term “stable” when used in conjunction with char formation means that char, or at least a sufficient amount of char, formed during the burning of the recited substrate remains attached to and part of that substrate so as not to expose new, unburned polymer. Finally, it is to be noted that unless indicated otherwise, all weight percents pertaining to the flame retardant additive(s) are based on the combined weight of the flame retardant additive(s) and the polyolefin.

The present teachings are directed to halogen free flame retardant cable filler materials, especially those made of foamed and/or fibrillated flame retardant polyolefins, and the cables made with the same. As discussed below, the cable filler material may take any number of forms, e.g., yarns, fibers, filaments, rods, tapes, strips, webs, etc., depending upon the specific application. Cable fillers in the form of yarns will have a Denier (D) of from about 800 D to 12,000 D, preferably from about 1200 D to about 5,000 D. Although higher denier yarns, up to 50,000 D or more (as known in the industry) may be used for those cable applications and designs that require a greater amount of fill; however, more typically, such applications will employ a plurality of stands of yams falling within the prior denier ranges. The foregoing dimensions generally hold true for web materials as well, especially spun web materials, when rolled into a cylindrical form. Cable fillers in the form of strips or tapes will typically have a width of from about 0.065 to as wide as 30″ or more, preferably from about 0.125″ to 20″ and a thickness of from about 0.5 mils to 20 mils or more, preferably from about 1 mil to about 15 mils, most preferably from about 4 mils to about 10 mils. The same figures hold true for fibrillated tapes and strips prior to their fibrillation. Finally, those cable fillers in the form of fibers, filaments and rods will typically have a diameter of from about 0.01 to 0.2″ or more, preferably from about 0.02″ to about 0.125, most preferably from about 005″ to about 0.1″. Of course, it is understood that hollow filaments may be employed in which case the diameters mentioned above pertain to the outer diameter. Furthermore, it is to be appreciated that while reference is made to rods, in reality these are the large diameter filaments since stiff rods will be difficult to work with. Finally, while reference is made to the continuous nature of the cable filler materials, it is to be appreciated that this means that these materials are made in a continuous manner so as to produce spools, reels or the like of a continuous length of the product and/or the process of their production can be directly integrated into the cable forming process.

There is no limit on the polyolefins which may be employed in the practice of the present teachings. Generally speaking, any polyolefin, including olefin homopolymers, copolymers and blends, including copolymers of wholly olefinic monomers and of olefinic and non-olefinic monomers as well as blends of polyolefins and blends of olefin polymers with other compatible thermoplastic polymers, may be used. Most especially suitable polyolefins include, but are not limited to, polyethylene, polypropylene, ethylene-propylene copolymers, polyethylene-propylene, thermoplastic olefin polymer (TPO), and the like.

Most preferably, the present teaching is applicable to cable fillers prepared of foamed polyolefins, with or without fibrillation, wherein the polyolefin is foamed with conventional foaming agents by conventional methods. Foaming agents include traditional gaseous blowing agents as well as chemical foaming agents that generate a gas under proper reactive conditions. These foaming agents may be used alone or in combination with nucleating agents which help control cell size and structure, e.g., open or closed cell structure, as well as uniformity of the foam. Generally speaking, the amount of foaming agent to be used is such as to produce a density reduction of from about 20% to about 60%, preferably from about 25% to about 50%, most preferably from about 30% to about 45%.

Surprisingly, as noted above, when a phosphorous flame retardant is present, one achieves a higher degree of foam, and hence density reduction, as compared to the same composition without the phosphorous flame retardant. Suitable foaming agents, whether blowing agents or chemical foaming agents, are well known and commercially available. Information pertaining to the specific amount to be used to achieve a given density is also well known in the art and/or publically available and/or may be determined by simple experimentation.

The polyolefins of the present teaching are rendered flame retardant by the use of one or more halogen free flame retardant additives. Most especially the flame retardant additives comprise (i) an NOR or NOROL hindered amine alone or, preferably, in combination with a (ii) flame retardant non-halogenated phosphorus compound. The NOR or NOROL hindered amine flame retardant is typically present in an amount of from about 0.5 to about 5 wt %, preferably from about 1 to about 2 wt %. When present, the non-halogenated phosphorous flame retardant compound is present in an amount of from about 10 to less than 30 wt %, preferably from about 15 to about 25 wt %. Surprisingly, as found by Horsey et, at, many of the NOR and NOROL hindered amine flame retardants suitable for use in the practice of the present teaching are most often associated with and noted for their stabilization characteristics.

The present sterically hindered amine stabilizers of component (i) are known in the art, and are for example of the formula

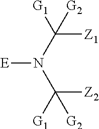

wherein
G₁ and G₂ are independently alkyl of 1 to 8 carbon atoms or are together pentamethylene,
Z₁ and Z₂ are each methyl, or Z₁ and Z₂ together form a linking moiety which may additionally be substituted by an ester, ether, amide, amino, carboxy or urethane group, and
E is oxyl, hydroxyl, alkoxy, cycloalkoxy, aralkoxy, aryloxy, —O—CO—O Z₃, —O—Si(Z₄)₃, —O—PO(O Z₅)₂ or —O—CH₂—OZ where Z₃, Z₄, Z₅ and Z are selected from the group consisting of hydrogen, an aliphatic, araliphatic and aromatic moiety;
   or E is —O-T-(OH)_{b} wherein
T is a straight or branched chain alkylene of 1 to 18 carbon atoms, cycloalkylene of 5 to 18 carbon atoms, cycloalkenylene of 5 to 18 carbon atoms, a straight or branched chain alkylene of 1 to 4 carbon atoms substituted by phenyl or by phenyl substituted by one or two alkyl groups of 1 to 4 carbon atoms and
b is 1, 2 or 3 with the proviso that b cannot exceed the number of carbon atoms in T, and when b is 2 or 3, each hydroxyl group is attached to a different carbon atoms of T,
   E is for example oxyl, hydroxyl, alkoxy, cycloalkoxy or aralkoxy. For instance, E is methoxy, propoxy, cyclohexyloxy or octyloxy.

The present sterically hindered amine stabilizers of component (i) are for example of the formula A-R

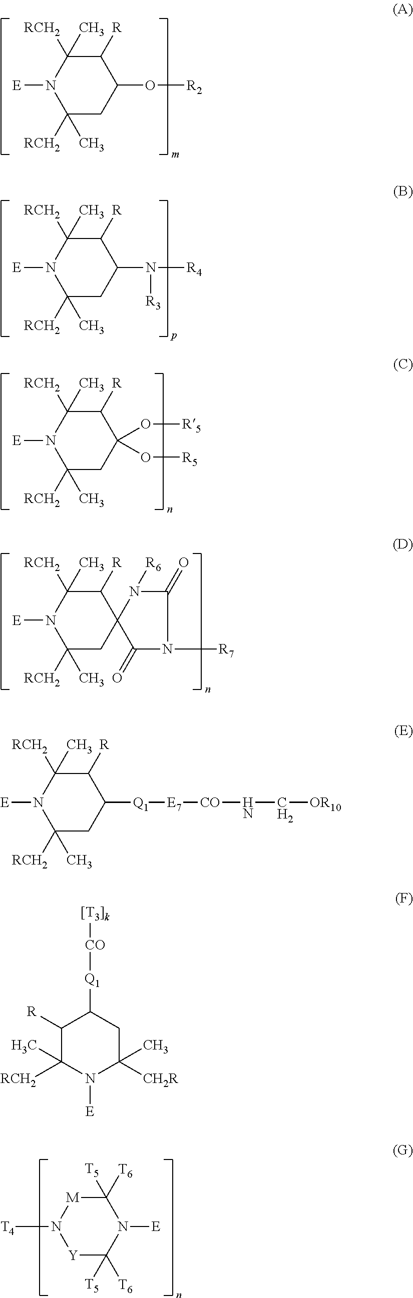

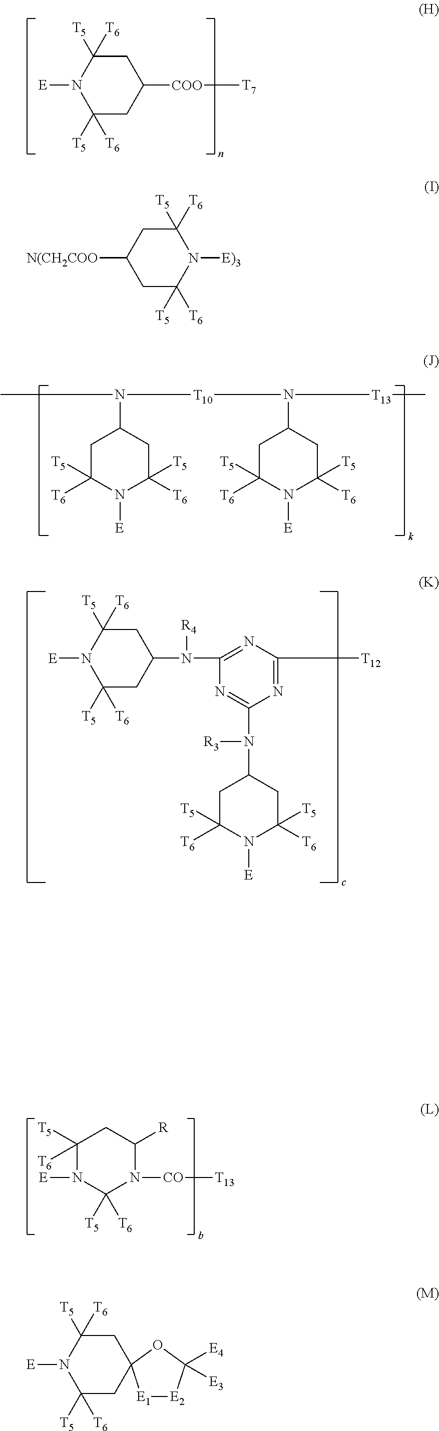

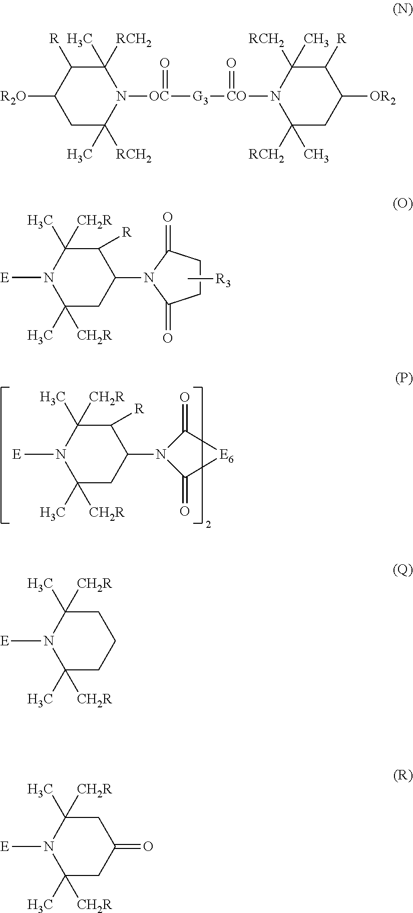

wherein
E is oxyl, hydroxyl, alkoxy of 1 to 18 carbon atoms, cycloalkoxy of 5 to 12 carbon atoms or aralkoxy of 7 to 15 carbon atoms, or E is -O-T-(OH)_{b},
T is a straight or branched chain alkylene of 1 to 18 carbon atoms, cycloalkylene of 5 to 18 carbon atoms, cycloalkenylene of 5 to 18 carbon atoms, a straight or branched chain alkylene of 1 to 4 carbon atoms substituted by phenyl or by phenyl substituted by one or two alkyl groups of 1 to 4 carbon atoms;
b is 1, 2 or 3 with the proviso that b cannot exceed the number of carbon atoms in T, and when b is 2 or 3, each hydroxyl group is attached to a different carbon atoms of T;
R is hydrogen or methyl,
m is 1 to 4, provided that:
when m is 1,
R₂ is hydrogen, C₁-C₁₈ alkyl or said alkyl optionally interrupted by one or more oxygen atoms, C₂-C₁₂ alkenyl, C₆-C₁₀ aryl, C₇-C₁₈ aralkyl, glycidyl, a monovalent acyl radical of an aliphatic, cycloaliphatic or aromatic carboxylic acid, or a carbamic acid, for example an acyl radical of an aliphatic carboxylic acid having 2-18 C atoms, of a cycloaliphatic carboxylic acid having 5-12 C atoms or of an aromatic carboxylic acid having 7-15 C atoms, or

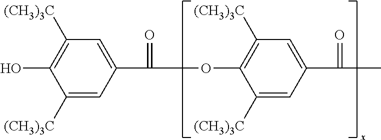

wherein x is 0 or 1, or

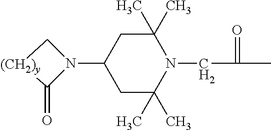

wherein y is 2 4;
when m is 2,
R₂ is C₁-C₁₂ alkylene, C₄-C₁₂ alkenylene, xylylene, a divalent acyl radical of an aliphatic, cycloaliphatic, araliphatic or aromatic dicarboxylic acid or of a dicarbamic acid, for example an acyl radical of an aliphatic dicarboxylic acid having 2-18 C atoms, of a cycloaliphatic or aromatic dicarboxylic acid having 8-14 C atoms, or of an aliphatic, cycloaliphatic or aromatic dicarbamic acid having 8-14 C atoms;

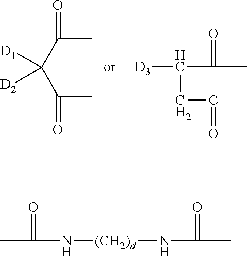

wherein D₁ and D₂ are independently hydrogen, an alkyl radical containing up to 8 carbon atoms, an aryl or aralkyl radical including 3,5-di-t-butyl-4-hydroxybenzyl radical, D₃ is hydrogen, or an alkyl or alkenyl radical containing up to 18 carbon atoms, and d is 0-20;
when m is 3,
R₂ is a trivalent acyl radical of an aliphatic, unsaturated aliphatic, cycloaliphatic, or aromatic tricarboxylic acid;
when m is 4,
R₂ is a tetravalent acyl radical of a saturated or unsaturated aliphatic or aromatic tetracarboxylic acid including 1,2,3,4-butanetetracarboxylic acid, 1,2,3,4-but-2-enetetracarboxylic, and 1,2,3,5- and 1,2,4,5-pentanetetracarboxylic acid
p is 1, 2 or 3,
R₃ is hydrogen, C₁-C₁₂ alkyl, C₅-C₇ cycloalkyl, C₇-C₈ aralkyl, C₂-C₁₅ alkanoyl, C₃-C₅ alkenoyl or benzoyl;
when p is 1,
R₄ is hydrogen, C₁-C₁₈ alkyl, C₅-C₇ cycloalkyl, C₂-C₈ alkenyl, unsubstituted or substituted by a cyano, carbonyl or carbamide group, aryl, aralkyl, or it is glycidyl, a group of the formula —CH₂—CH(OH)—Z or of the formula —CO—Z or —CONH—Z wherein Z is hydrogen, methyl or phenyl; or a group of the formulae

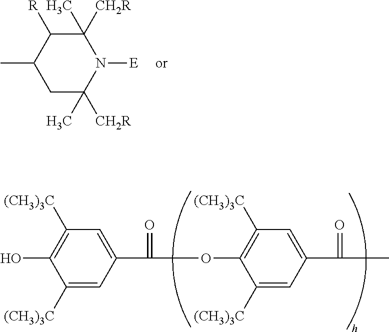

where h is 0 or 1,
R₃ and R₄ together, when p is 1, can be alkylene of 4 to 6 carbon atoms or 2-oxo-polyalkylene the cyclic acyl radical of an aliphatic or aromatic 1,2- or 1,3-dicarboxylic acid,
when p is 2,
R₄ is a direct bond or is C₁-C₁₂ alkylene, C₆-C₁₂ arylene, xylylene, a —CH₂CH(OH)—CH₂ group or a group —CH₂13 CH(OH)—CH₂—O—X—O—CH₂—CH(OH)-CH₂— wherein X is C₂-C₁₀ alkylene, C₆-C₁₅ arylene or C₆-C₁₂ cycloalkylene; or,
   provided that R₃ is not alkanoyl, alkenoyl or benzoyl, R₄ can also be a divalent acyl radical of an aliphatic, cycloaliphatic or aromatic dicarboxylic acid or dicarbamic acid, or can be the group —CO—; or
R₄ is

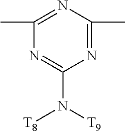

where T₈ and T₉ are independently hydrogen, alkyl of 1 to 18 carbon atoms, or T₈ and T9 together are alkylene of 4 to 6 carbon atoms or 3-oxapenta-methylene, for instance T₆ and T₉ together are 3-oxapentamethylene;
when p is 3,
R₄ is 2,4,6-triazinyl,
n is 1 or 2,
when n is 1.
R₅ and R₁₅ are independently C₁-C₁₂ alkyl, C₂-C₁₂ alkenyl, C₇-C₁₂ aralkyl, or R₅ is also hydrogen, or R₅ and R₁₅ together are C₂-C₈ alkylene or hydroxyalkylene or C₄-C₂₂ acyloxyalkylene;
when n is 2,
R₅ and R₁₅ together are (—CH₂)₂C(CH₂—)₂;
R₆ is hydrogen, C₁-C₁₂ alkyl, allyl, benzyl, glycidyl or C₂-C₆ alkoxyalkyl;
when n is 1,
R₇ is hydrogen, C₁-C₁₂ alkyl, C₃-C₅ alkenyl, C₇-C₉ aralkyl, C₅-C₇ cycloalkyl, C₂-C₄ hydroxyalkyl, C₂-C₆ alkoxyalkyl, C₆-C₁₀ aryl, glycidyl, a group of the formula —(CH₂)ₜ—COO-Q or of the formula —(CH₂)ᵣ—O—CO-Q wherein t is 1 or 2, and Q is C₁-C₄ alkyl or phenyl; or
when n is 2,
R₇ is C₂-C₁₂ alkylene, C₆-C₁₂ arylene, a group —CH₂CH(OH)—CH₂—O—X—O—CH₂—CH(OH)CH₂— wherein X is C₂-C₁₀ alkylene, C₂-C₁₅ arylene or C₆-C₁₂ cycloalkylene, or a group CH₂CH(OZ′)CH₂—(OCH₂—CH(OZ′)CH₂)₂— wherein Z′ is hydrogen, C₁-C₁₈ alkyl, allyl, benzyl, C₂-C₁₂ alkanoyl or benzoyl;
Q₁ is —N(R₈)— or —O—;
E₇ is C₁-C₃ alkylene, the group —CH₂—CH(R₉)—O— wherein R₉ is hydrogen, methyl or phenyl, the group —(CH₂)₃—NH— or a direct bond;
R₁₀ is hydrogen or C₁-C₁₈ alkyl, R₈ is hydrogen, C₁-C₁₈ alkyl, C₅-C₇ cycloalkyl, C₇-C₁₂ aralkyl, cyanoethyl, C₆-C₁₀ aryl, the group —CH₂—CH(R₉)—OH wherein R₉ has the meaning defined above; a group of the formula

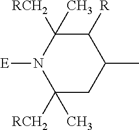

or a group of the formula

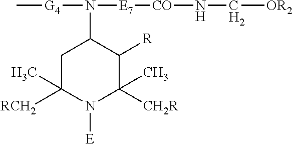

wherein G₄ is C₂-C₆ alkylene or C₆-C₁₂ arylene; or R₈ is group -E₇-CO—NH—CH₂—O R₁₀;

Formula F denotes a recurring structural unit of a polymer where T₃ is ethylene or 1,2-propylene, is the repeating structural unit derived from an alpha-olefin copolymer with an alkyl acrylate or methacrylate; for example a copolymer of ethylene and ethyl acrylate, and where k is 2 to 100;
T₄ has the same meaning as R₄ when p is 1 or 2,
T₅ is methyl,
T₆ is methyl or ethyl, or T₅ and T₆ together are tetramethylene or pentamethylene, for instance T₅ and T₆ are each methyl,
M and Y are independently methylene or carbonyl, and T₄ is ethylene where n is 2;
T₇ is the same as R₇, and T₇ is for example octamethylene where n is 2,
T₁₀ and T₁₁ are independently alkylene of 2 to 12 carbon atoms, or T₁₁ is

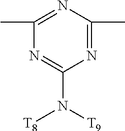

T₁₂ is piperazinyl,

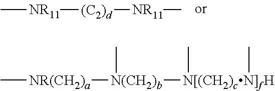

where R₁₁ is the same as R₃ or is also

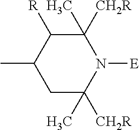

a, b and c are independently 2 or 3, and f is 0 or 1, for instance a and c are each 3, b is 2 and f is 1; and
e is 2, 3 or 4, for example 4;
T₁₃ the same as R₂ with the proviso that T₁₃ cannot be hydrogen when n is 1;
E₁ and E₂ being different, each are —CO— or —N(E₅)- where E₅ is hydrogen, C₁-C₁₂ alkyl or C₄-C₂₂ alkoxycarbonylalkyl, for instance E₁ is —CO— and E₂ is —N(E₅)-,
E₃ is hydrogen, alkyl of 1 to 30 carbon atoms, phenyl, naphthyl, said phenyl or said naphthyl substituted by chlorine or by alkyl of 1 to 4 carbon atoms, or phenylalkyl of 7 to 12 carbon atoms, or said phenylalkyl substituted by alkyl of 1 to 4 carbon atoms,
E₄ is hydrogen, alkyl of 1 to 30 carbon atoms, phenyl, naphthyl or phenylalkyl of 7 to 12 carbon atoms, or
E₃ and E₄ together are polymethylene of 4 to 17 carbon atoms, or said polymethylene substituted by up to four alkyl groups of 1 to 4 carbon atoms, for example methyl,
E₆ is an aliphatic or aromatic tetravalent acid R₂ of formula (N) is a previously defined when m is 1;
G₁ a direct bond, C₁-C₁₂ alkylene, phenylene or —NH-G′-NH wherein G′ is C₁-C₁₂, alkylene; or
wherein the hindered amine compound is a compound of the formula I, II, III, IV, V, VI, VII, VIII, IX, X or XI

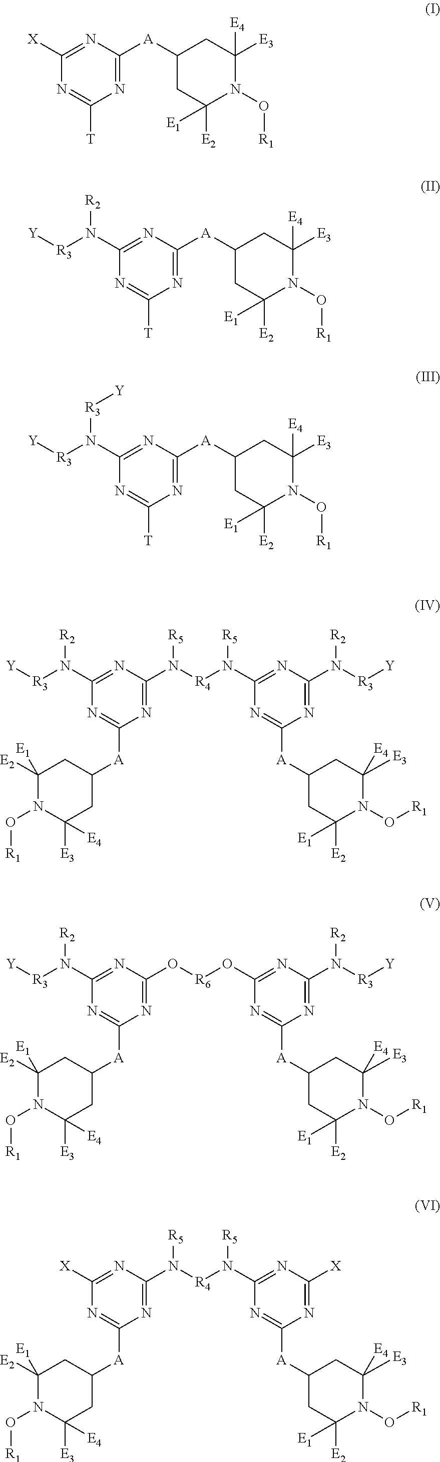

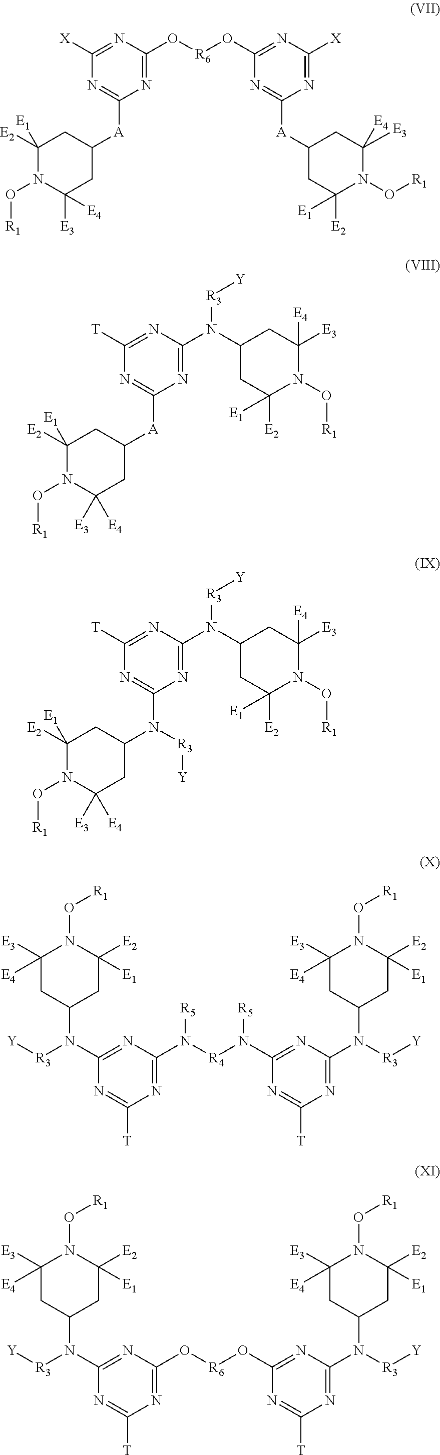

wherein
E₁, E₂, E₃ and E₄ are independently alkyl of 1 to 4 carbon atoms, or E₁ and E₂ are independently alkyl of 1 to 4 carbon atoms and E₃ and E₄ taken together are pentamethylene, or E₁ and E₂; and E₃ and E₄ each taken together are pentamethylene,
R₁ is alkyl of 1 to 18 carbon atoms, cycloalkyl of 5 to 12 carbon atoms, a bicyclic or tricyclic hydrocarbon radical of 7 to 12 carbon atoms, phenylalkyl of 7 to 15 carbon atoms, aryl of 6 to 10 carbon atoms or said aryl substituted by one to three alkyl of 1 to 8 carbon atoms,
R₂ is hydrogen or a linear or branched chain alkyl of 1 to 12 carbon atoms,
R₃ is alkylene of 1 to 8 carbon atoms, or R₃ is —CO—, —CO—R₄—, —CONR₂—, or —CO—NR₂—R₄—,
R₄ is alkylene of 1 to 8 carbon atoms,
R₅ is hydrogen, a linear or branched chain alkyl of 1 to 12 carbon atoms, or

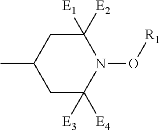

or when R₄ is ethylene, two R₅ methyl substituents can be linked by a direct bond so that the triazine bridging group —N(R₅)—R₄—N(R₅)— is a piperazin-1,4-diyl moiety,
R₆ is alkylene of 2 to 8 carbon atoms or R₆ is

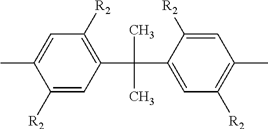

with the proviso that Y is not —OH when R₆ is the structure depicted above,
A is —O— or —NR₇— where R7 is hydrogen, a straight or branched chain alkyl of 1 to 12 carbon atoms, or R₇ is

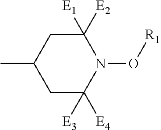

T is phenoxy, phenoxy substituted by one or two alkyl groups of 1 to 4 carbon atoms, alkoxy of 1 to 8 carbon atoms or —N(R₂)₂ with the stipulation that R₂ is not hydrogen, or T is

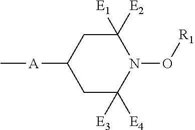

X is —NH₂, —NCO, —OH, —O-glycidyl, or —NHNH₂, and
Y is —OH, —NH₂, —NHR₂ where R₂ is not hydrogen; or Y is —NCO, —COOH, oxiranyl, —O-glycidyl, or —Si(OR₂)₃; or the combination R₃—Y— is —CH₂CH(OH)R₂ where R₂ is alkyl or said alkyl interrupted by one to four oxygen atoms, or R₃—Y— is —CH₂OR₂;
or
   wherein the hindered amine compound is a mixture of NN′,N′″-tris{2,4-bis[(1-hydrocarbyloxy-2,2,6,6-tetramethylpiperidin-4-y-l)alkylamino]-s-triazin-6-yl}-3,3′-ethylenediiminodipropylamine; N,N′,N″-tris{2,4-bis[(1-hydrocarbyloxy-2,2,6,6-tetramethylpiperidin-4-yl-)alkylamino]-s-triazin-6-yl}-3,3′-ethylenediimino-dipropylamine, and bridged derivatives as described by formulas I, II, IIA and III

R₁NH—CH₂CH₂CH₂N R₂CH₂CH₂N R₃CH₂CH₂CH₂NH R₄ (I)

T-E₁-T₁ (II)

T-E₁ (IIA)

G-E₁-G₁-E₁-G₂ (III)

wherein in the tetraamine of formula I
R₁ and R₂ are the s-triazine moiety E; and one of R₃ and R₄ is the s-triazine moiety E with the other of R₃ or R₄ being hydrogen.
E is

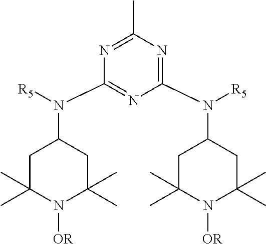

wherein R is methyl, propyl, cyclohexyl or octyl, for instance cyclohexyl,
R₅ is alkyl of 1 to 12 carbon atoms, for example n-butyl,
   where in the compound of formula II or IIA when R is propyl, cyclohexyl or octyl,
T and T₁ are each a tetraamine substituted by R₁-R₄ as is defined for formula I, where
(1) one of the s-thiazine moieties E in each tetraamine is replaced by the group Eₗ which forms a bridge between two tetraamines T and T₁,
E₁ is

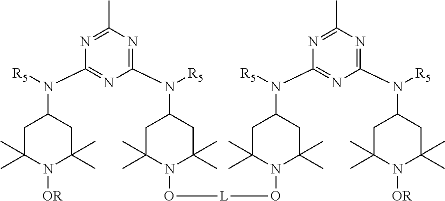

or
(2) the group E₁ can have both termini in the same tetraamine T as in formula IIA where two of the E moieties of the tetraamine are replaced by one E₁ group, or
(3) all three s-triazine substituents of tetraamine T can be E₁ such that one E₁ links T and T₁ and a second E₁ has both termini in tetraamine T,
L is propanediyl, cyclohexanediyl or octanediyl;
   where in the compound of formula III
G, G₁ and G₂ are each tetraamines substituted by R₁-R₄ as defined for formula I, except that G and G₂ each have one of the s-triazine moieties E replaced by E₁, and G₁ has two of the triazine moieties E replaced by E₁, so that there is a bridge between G and G₁ and a second bridge between G₁ and G₂;
which mixture is prepared by reacting two to four equivalents of 2,4-bis[(1-hydrocarbyl-oxy-2,2,6,6-etramethylpiperidin-4-yl)butylamino]-6-chloro-s-triazine with one equivalent of N,N′-bis(3-aminopropyl)ethylenediamine;
   or the hindered amine is a compound of the formula IIIb

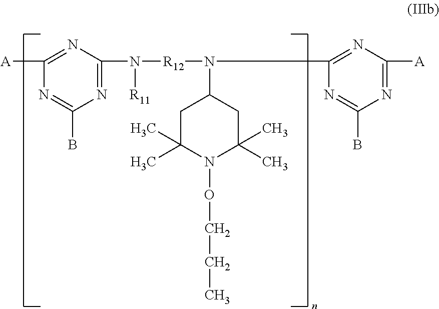

in which the index n ranges from 1 to 15;
R₁₂ is C₂-C₁₂ alkylene, C₄-C₁₂ alkenylene, C₅-C₇ cycloalkylene, C₅-C₇ cycloalkylene-di(C₁-C₄ alkylene), C₁-C₄ alkylene-di(C₅-C₇ cycloalkylene), phenylene-di(C₁-C₄ alkylene) or C₄-C₁₂ alkylene interrupted by 1,4-piperazinediyl, —O— or >N—X₁ with X₁ being C₁-C₁₂ acyl or (C₁-C₁₂ alkoxy)carbonyl or having one of the definitions of R₁₄ given below except hydrogen; or R₁₂ is a group of the formula (Ib′) or (Ic′);

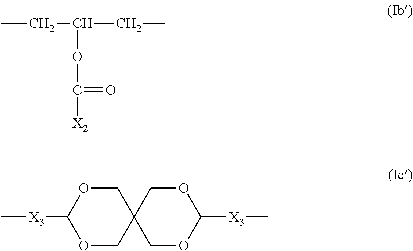

with m being 2 or 3,
X₂ being C1-C₁₈ alkyl, C₅-C₁₂ cycloalkyl which is unsubstituted or substituted by 1, 2 or 3 C₁-C₄ alkyl; phenyl which is unsubstituted or substituted by 1, 2 or 3 C₁-C₄ alkyl or C₁-C₄ alkoxy; C₇-C₉ phenylalkyl which is unsubstituted or substituted on the phenyl by 1, 2 or 3 C₁-C4 alkyl; and
the radicals X₃ being independently of one another C₂-C₁₂ alkylene;
R₁₃, R₁₄ and R₁₅, which are identical or different, are hydrogen, C₁-C₁₈ alkyl, C₅-C₁₂ cycloalkyl which is unsubstituted or substituted by 1, 2 or 3 C₁-C₄ alkyl; C₃-C₁₈ alkenyl, phenyl which is unsubstituted or substituted by 1, 2 or 3 C₁-C₄ alkyl or C₁-C₄ alkoxy; C₇-C₉ phenylalkyl which is unsubstituted or substituted on the phenyl by 1, 2 or 3 C₃-C₄ alkyl; tetrahydrofurfuryl or C₂-C₄ alkyl which is substituted in the 2, 3 or 4 position by —OH, C₁-C₈ alkoxy, di(C₁-C₄ alkylamino or a group of the formula (Ie′);

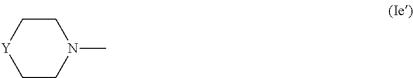

with Y being —O—, —CH₂—, —CH₂CH₂— or >N—CH₃,
or —N(R₁₄)(R₁₅) is additionally a group of the formula (Ie′);
the radicals A are independently of one another —OR₁₃, —N(R₁₄)(R₁₅) or a group of the formula (IIId);

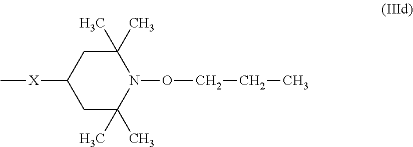

where X is —O— or >N—R₁₆; wherein R₁₆ is hydrogen, C₁-C₁₈ alkyl, C₃-C₁₈ alkenyl, C₅-C₁₂ cycloalkyl which is unsubstituted or substituted by 1, 2 or 3 C₁-C₄ alkyl; C₇-C₉ phenylalkyl which is unsubstituted or substituted on the phenyl by 1, 2 or 3 C₁-C₄ alkyl; tetrahydrofurfuryl, a group of the formula (IIIf),

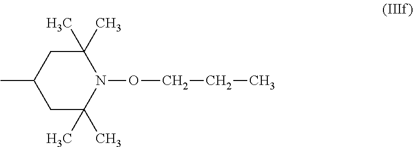

or C₂-C₄ alkyl which is substituted in the 2, 3 or 4 position by —OH, C₁-C₈ alkoxy, di(C₁-C₄ alkyl)amino or a group of the formula (Ie′);
R₁₁ has one of the definitions given for R₁₆; and
the radicals B have independently of one another one of the definitions given for A.

Alkyl is straight or branched and is for example methyl, ethyl, n-propyl, n-butyl, sec-butyl, tert-butyl, n-hexyl, n-octyl, 2-ethylhexyl, n-nonyl, n-decyl, n-undecyl, n-dodecyl, n-tridecyl, n-tetradecyl, n-hexadecyl or n-octadecyl.

Cycloalkyl groups include cyclopentyl and cyclohexyl; typical cycloalkenyl groups include cyclohexenyl; while typical aralkyl groups include benzyl, alpha-methyl-benzyl, alpha,alphadimethylbenzyl or phenethyl.

If R₂ is a monovalent acyl radical of a carboxylic acid, it is for example an acyl radical of acetic acid, stearic acid, salicyclic acid, benzoic acid or .beta.-(3,5-di-tert-butyl-4-hydroxyphenyl)propionic acid.

If R₂ is a divalent acyl radical of a dicarboxylic acid, it is for example an acyl radical of oxalic acid, adipic acid, succinic acid, suberic acid, sebacic acid, phthalic acid dibutylmalonic acid, dibenzylmalonic acid or butyl-(3,5-di-tert-butyl-4-hydropxybenzylymalonic acid, or bicycloheptenedicarboxylic acid, with succinates, sebacates, phthalates and isophthalates being specific examples.

If R₂ is a divalent acyl radical of a dicarbamic acid, it is for example an acyl radical of hexamethylenedicarbamic acid or of 2,4-toluylenedicarbamic acid.

Hindered alkoxyamine stabilizers of component (i) are well known in the art, also known as N-alkoxy hindered amines and NOR hindered amines or NOR hindered amine light stabilizers or NOR HALS. They are disclosed for example in U.S. Pat. Nos. 5,004,770, 5,204,473, 5,096,950, 5,300,544, 5,112,890, 5,124,378, 5,145,893, 5,216,156, 5,844,026, 6,117,995, 6,271,377, and U.S. application Ser. No. 09/505,529, filed Feb. 17, 2000, Ser. No. 09/794,710, filed Feb. 27, 2001, Ser. No. 09/714,717, filed Nov. 16, 2000, Ser. No. 09/502,239, filed Nov. 3, 1999 and 60/312,517, filed Aug. 15, 2001. The relevant disclosures of these patents and applications are hereby incorporated by reference.

U.S. Pat. No. 6,271,377, and U.S. application Ser. No. 09/505,529, filed Feb. 17, 2000, and Ser. No. 09/794,710, filed Feb. 27, 2001, cited above disclose hindered hydroxyalkoxyamine stabilizers. For the purposes of this teaching, the hindered hydoxyalkoxyamine stabilizers are considered a subset of the hindered alkoxyamine stabilizers and are part of present component (i). Hindered hydroxyalkoxyamine stabilizers are also known as N-hydroxyalkoxy hindered amines, or NOROL HALS.

Suitable hindered amines of component (i) include for example:
NOR1 1-cyclohexyloxy-2,2,6,6-tetramethyl-4-octadecylaminopiperidine;
NOR2 bis(1-octyloxy-2,2,6,6-tetramethylpiperidin-4-yl)sebacate;
NOR3 2,4-bis[(1-cyclohexyloxy-2,2,6,6-tetramethylpiperidin-4-yl)butylamin-o]-6-(2-hydroxyethylamino-s-triazine;
NOR4 2,4-bis[(1-cyclohexyloxy-2,2,6,6-tetramethylpiperidin-4-y)butylamin-o]-6-chloro-s-triazine;
NOR5 1-(2-hydroxy-2-methylpropoxy)-4-hydnoxy-2,2,6,6-tetramethylpiperidin-e;
NOR6 1-(2-hydroxy-2-methylpropoxy)-4-oxo-2,2,6,6-tetramethylpiperidine;
NOR7 1-(2-hydroxy-2-methylpropoxy)-4-octadecanoyloxy-2,2,6,6-tetramethylp-iperidine;
NOR8 bis(1-(2-hydroxy-2-methylpropoxy)-2,2,6,6-tetramethylpiperidin-4-yl)-sebacate;
NOR9 bis(1-(2-hydroxy-2-methylpropoxy)-2,2,6,6-tetramethylpiperidin-4-yl)-adipate;
NOR10 2,4-bis{N-[1-(2-hydroxy-2-methylpropoxy)-2,2,6,6-tetramethylpiperid-in-4-yl]-N-butylamino}-6-(2-hydroxyethylamino)-s-triazine;
NOR11 the reaction product of 2,4-bis[(1-cyclohexyloxy-2,2,6,6-tetramethylpiperidin-4-yl)butylamino]-6-chloro-s-triazine with N,N′-bis(3-aminopropyl)ethylenediamine) [CAS Reg. No. 191680-81-6];
NOR12 the compound of formula

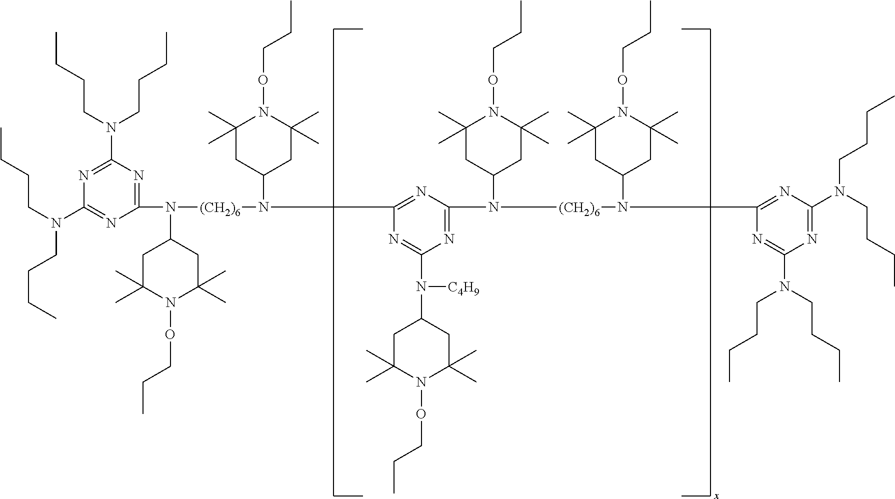

in which n is from 1 to 15; and
NOR13 bis(1-cyclohexyloxy-2,2,6,6-tetramethylpiperidin-4-yl)adipate.

Compound NOR12 is disclosed in example 2 of U.S. Pat. No. 6,117,995.

Optionally, though preferably, the aforementioned NOR and NOROL hindered amines are used in combination with a halogen-free phosphorous based flame retardant additive. Such phosphorous based flame retardant additives are well known and commercially available. Exemplary phosphorous based flame retardants include tetraphenyl resorcinol diphosphite (FYROLFLEX® RDP, Akzo Nobel), triphenyl phosphate, trioctyl phosphate, tricresyl phosphate, tetrakis(hydroxymethyl)phosphonium sulfide, diethyl-N,N-bis-2-hydroxyethyl)-aminomethyl phosphonate, hydroxyalkyl esters of phosphorous acids, ammonium polyphosphate (APP) or (HOSTAFLAM® AP750), resorcinol diphosphate oligomers (RDP), phosphazene flame retardants and ethylenediamine diphosphate (EDAP).

As noted above, the amount of phosphorous flame retardant material employed is from about 10 to less than 30 wt %, preferably from about 15 to about 25 wt %, based on the combined weight of the flame retardant additives and the polymer. However, where the phosphorous flame retardant is hygroscopic and/or hydrophilic in nature, the amount by which it is used should be less than 25 wt %, preferably about 20 wt % or less to avoid processing difficulties. Specifically, while the higher amounts may be used, water carrying over from the quenching/cooling baths following extrusion may make it more difficult to fibrillate, orient, slit, and/or further process the tow of material. On the other hand, again as noted above, it has also been found that the use of the phosphorous flame retardant provides an enhanced foaming action whereby foam density, i.e., g/cm³, is less than attained in the absence of the phosphorous flame retardant when using the same quantity of foaming agent, especially a chemical foaming agent. For example, it has been found that whereas one may typically employ a chemical foaming agent at a concentration of 0.5 wt % based on the weight of the total composition, we are able to attain the same degree of foam density with just half that amount, 0.25 wt %, sometimes even as low as 0.1 wt %. Of course, those skilled in the art will readily appreciate that the actual amount of foaming agent to be used will depend upon the degree of foaming and ultimate physical properties desired of the final product. Such information is typically known in the art or can be ascertained by simple experimentation.

The flame retardant polyolefin compositions used in manufacturing the insulating cable filler materials of the present teaching are all prepared according to well known processes. To aid or enhance the processability of the materials, it is desirable to form, i.e., precompound, a masterbatch of the flame retardant additive with polypropylene or another compatible polymer, which masterbatch is then added to the desired polyolefin material to let down the flame retardant additive to the desired concentration.

As noted above, standard cable fillers often use the addition of foaming agents, especially chemical foaming agents (CFAs), to achieve a reduction of density. This can improve electrical insulation as well as signal performance. Foaming agents may be added to the polymer composition concurrent with the formation process for the cable filler material or, in the case of chemical foaming agents, may also be compounded into the polymer composition in its un-reacted state, which is them stored or shipped to the ultimate processor of the cable filler material, with foaming occurring concurrent with the formation of the cable filler itself. In either instance, the chemical foaming agent may also be precompounded into a masterbatch formulation, which may be the same as the flame retardant masterbatch or a different masterbatch. Other additives, such as colorants, stabilizers, etc., may also be incorporated into these or separate masterbatches as well. Most preferably, especially due to ease of use by the converter to a cable filler material, the compositions are prepared as fully formulated resins or foamable resins, as appropriate, in pelletized form.

The desired cable filler material may be made from these compositions according to well known and practiced methodologies. For example, the fully formulated pelletized compositions may be spun into fiber using a fiber extruder wherein the spun fiber is subsequently stretched to the desired denier of the fiber. Multiple spun fibers or a multi-die extrusion head may be used to form yarns and ropes from the polymer melt which are then used as cable fillers, as appropriate. Non-woven spun bonded materials (webs) may also be prepared and subsequently cut to width. Alternatively, the compositions may be extruded through various extrusion dies to form films, sheets, strips, rods and the like, again depending upon the final desired form of the cable filler. For foamed cable fillers, if a gaseous blowing agent is employed, it is typically added to the melt as it is being extruded. Chemical foaming agents, on the other hand, are activated in-situ, within the polymer melt, at or near the extrusion die by the conditions within the extruder. Oftentimes, the actual gas is not formed, or minimally so, until the melt reaches the extrusion die outlet and the pressure on the melt is relieved as it exits the die, thereby allowing for the expansion of the gases within. In either case, the strip, sheet or film of material may be extruded to the proper width or it may be extruded in large widths which are subsequently slit to the appropriate width for commercial use. Alternatively or in addition to the foregoing processes, the cable filler of the present teachings may also be fibrillated wherein the extruded tape, film or strip is subjected to traditional fibrillation processes. All of these processes and the conditions therefore are well know or readily attained through traditional process implementation and optimization.

The final dimensions of the cable filler materials made in accordance with the present teachings will depend upon the particular cable into which they are to be incorporated and its current/voltage carrying capacity Generally speaking, those skilled in the art will readily appreciate the dimensions to be used as they are consistent with current commercial practices the difference being the unique and advantageous flame retardant characteristics attained with the use of the specified non-halogen flame retardant additives. Typically, though not always, manufacturers employ a number of different sized cable fillers, particularly different denier yarns or strands, in the same cable to better stabilize the cable elements and provide a more uniform (symmetrical) and consistent shape and diameter to the cable itself. Irrespective of the physical dimensions of the cable filler materials, it is most preferable that the cable filler materials according to the present teaching are foamed materials, particularly foamed yarns or strips, especially fibrillated foamed yarns and strips.

Applicant has now found that the “halogen-free” cable filler materials made in accordance with the present teachings provide excellent flame retardant properties provided that they are used in a manner whereby the cable filler is supported within the cable housing, especially wherein the support arises from a non-flammable component of the cable. Merely wrapping or winding the cable filler materials around the wires or the assembly of wires in a cable casing or aligning the cable filler material with the wires, both as found with many commercial cables using conventional halogenated flame retardant additives, will not provide or enable suitable flame retardant properties for commercial use in wire and cable applications. This is especially true with the foamed and/or fibrillated cable filler materials made as thin, fibrillated tapes in accordance with the present teachings which, owing in part to their high surface area, are more flammable than their non-foamed and/or non-fibrillated versions.

While the cable filler materials according to the present teachings do form a char upon burning, the char formed has insufficient physical integrity to provide adequate flame retardant properties, especially for wire and cable installations. Specifically, owing in part to the intumescent nature of the char formation, the char quickly falls away from the cable filler material before a suitable and stable amount, i.e., that amount which will extinguish the flame and remain in place, is formed, thereby exposing fresh cable filler material to the air and fire. However, Applicants have surprisingly found that if the cable filler material is twisted, intertwined, interleafed, or otherwise entangled (altogether “intertwined”) with itself, most especially with one or more other non-flammable components of the cable, one can achieve suitable flame retardant properties to make it suitable for wire and cable applications. For example, the cable filler materials may be intertwined with the conductive wires of the cable or with one or more stiffening wires within the cable housing or a wire or wire mesh may be wound around the conductive wires and the cable filler materials securing the cable filler to the wires. In essence, any non-flammable material may be used to hold the cable filler in place so long as a sufficient char is formed and not allowed to fall away.

Having described the teaching in general terms, Applicant now turns to the following examples in which specific combinations of flame retardant additives and different forms of the cable filler materials were prepared and evaluated. These examples are presented as demonstrating the surprising attributes of the cable filler materials of the present teaching as well as their unexpected utility in wire and cable applications when used in a manner whereby the char is physically stabilized. These examples are merely illustrative of the teaching and are not to be deemed limiting thereof. Those skilled in the art will recognize many variations that are within the spirit of the teaching and scope of the claims.

### EXAMPLES

### Example 1

Following the teachings of Horsey et. al., particularly Horsey et. al.'s exemplification of flame retardant polyolefins and foamed polyolefins, including those wherein the polymer was polypropylene, Applicants initiated efforts to produce foamed flame retardant polypropylene cable fillers. However, despite the exemplifications of Horsey et. al., Applicants' efforts were completely stymied by the finding that while the flame retardant additives could be physically incorporated into the polypropylene polymer, their incorporation rendered the resultant polymers, especially the foamed materials, essentially incapable of being processed into thin films for slitting and/or fibrillation or, if such materials were made, did not provide the flame retardant properties required of flame retardant wire and cable fillers. In particular, these materials did not provide sufficient self-extinguishing characteristics, generated too much smoke, and/or failed standard LOI (limited oxygen index) testing. (See Series 1 Table 2)

Undaunted, Applicants continued their investigation, focusing instead on the formation of extruded rods of 0.2 inch diameter which were then subjected to various burn tests to assess their general flame retardant characteristics: recognizing that if they were not appropriate in this form, they certainly would not be in the form of a foamed strip or yam or a fibrillated strip or yarn, and certainly not a foamed and fibrillated strip or yarn. (Series 2-Table 2) Even as Applicant began to attain sufficient flame retardant properties, other problems persisted. In particular, Applicant continued to experience difficulties in processing the materials into cable fillers, especially in their efforts to orient, slit and/or fibrillate the materials. Such difficulties were subsequently found to arise, at least in part, from water that was carried over from the quenching process following extrusion of the flame retardant cable filler material during formation. In following, it was found the amount of those flame retardant, and other, additives that were hygroscopic and/or hydrophilic in nature should be limited to minimize the carryover of water.

After much effort Applicants found significant advancement in the ability of their compositions to achieve many of the target flame retardant properties required of wire and cable fillers; however, still problems existed, particularly with respect to self-extinguishing and burn duration properties, especially the lack of sufficient char formation and stability (Series 3-Table 2). It was only by happenstance that Applicant found that by forming a stable char and/or building in a support for the char formed, i.e., holding the char together, one could achieve an efficacious and commercially suitable flame retardant cable filler. Specifically, it was found that by physically preventing the char from falling away from the burning cable filler, one could prepare wire and cable filler material that met flame retardant parameters for commercial wire and cable applications. In following, Applicant ascertained that by intertwining and/or otherwise binding the cable filler materials to a non-flammable component of the cable, the char formed upon burning did not fall away and enabled sufficient char formation such that the flame self-extinguished and did not reinitiate. (Series 4-Table 2, wherein the strips of foamed material were woven together to provide better structural integrity).

A sampling of the series of materials evaluated and the results attained therewith are set forth in Table 2. All examples employ polypropylene plus the weight percent of the indicated additive(s) such that the total composition comprised 100%.

TABLE 2

| | | | | | | | |
|---|---|---|---|---|---|---|---|
| | FRI * | Smoke | Char | Char | Burn Duration | | |
| Product Version | (%) | Amount | Formation | Stability | ASTM D2863 | LOI | Other Comments |

Series 1 - extruded film strips of 1.5 inch width, 5 inch length and 0.007 inch thick

| | | | | | | | | |
|---|---|---|---|---|---|---|---|---|
| 1-A | Superbulk ® FR PP | | Heavy | little | n/a | <10 seconds | ≧26 | Commercial Cable Filler |
| | Cable filler | | black | | | | | w/halogenated FR |
| 1-B | 1% NOR 116 | 1 | Heavy | little | n/a | >30 seconds | 20 | Sample did not extinguish |
| | | | black | | | | | |
| 1-C | 2% NOR 116 | 2 | Heavy | little | n/a | >30 seconds | 21 | Sample did not extinguish |
| | | | black | | | | | |
| 1-D | 1.5% NOR 116 plus | 21.5 | Black | Some char | Not stable | >30 seconds | 23 | Char falls apart and |
| | 20% Exolit 760 | | | | | | | flame re-starts |
| 1-E | 1.5% NOR 116 plus | 26.5 | Black | Some char | Not stable | >30 seconds | 24 | Char falls apart and |
| | 25% Exolit 760 | | | | | | | flame re-starts |
| 1-F | 1.5% NOR 116 plus | 31.5 | Black | Some char | Not stable | >30 seconds | n/a | Too much water carry |
| | 30% Exolit 760 | | | | | | | over made sample wet |
| 1-G | 1.5% NOR 116 plus | 51.5 | Black | Some char | Not stable | >30 seconds | n/a | Too much water carry |
| | 50% Exolit 760 | | | | | | | over made sample wet |
| 1-H | 1.6% NOR 116 plus | 13.8 | Black | Some char | Not stable | >30 seconds | 25 | Char falls apart and |
| | 12% Exolit 760 | | | | | | | flame restarts |
| 1-I | 1.6% NOR 116 plus | 17.6 | Black | Some char | Not stable | >30 seconds | Some 26 | Char falls apart and |
| | 16% Exolit 760 | | | | | | | flame restarts |
| 1-J | 1.6% NOR 116 plus | 21.6 | Black | Some char | Not stable | >30 seconds | Some 26 | Inconsistent results - |
| | 20% Exolit 760 | | | | | | | Char falls apart |

Series 2 - extruded foamed rod of 0.2 inch diameter and 6 inch length

| | | | | | | | | |
|---|---|---|---|---|---|---|---|---|
| 2-A | 100% PP | 0 | Black | little | n/a | >30 seconds | 18 | Virgin PP |
| 2-B | 1.5% NOR 116 | 1.5 | Black | little | n/a | >30 seconds | 20.3 | Sample continued to burn |
| | | | | | | | | without forming char |
| 2-C | 15% Exolit 760 | 15 | Black | Some char | Stable | <15 seconds | 28.7 | Good char formation |
| 2-D | 15% Exolit 760 plus | 16.5 | Black | Some char | Stable | <15 seconds | 30.1 | Burn extinguished |
| | 1.5% NOR 116 | | | | | | | |
| 2-E | 20% Exolit 760 | 20 | Black | Some char | Stable | <15 seconds | 27.1 | Good char |
| 2-F | 20% Exolit 760 plus | 21.5 | Black | Some char | Stable | <15 seconds | 29.4 | Burn extinguished |
| | 1.5% NOR 116 | | | | | | | |
| 2-G | 3.1% Exolit 760 | 3.1 | Black | Some char | Stable | <15 seconds | 19.7 | Samples continued to burn |
| 2-H | 3.1% Exolit 760 plus | 4.7 | Black | Some char | Not stable | <25 seconds | 20.6 | withourt forming good char |
| | 1.5% NOR 116 | | | | | | | |
| 2-I | 4.7% Exolit 760 | 4.7 | Black | Some char | Not stable | <130 seconds | 19.4 | |
| 2-J | 4.7% Exolit 760 plus | 6.2 | Black | Some char | Not stable | <25 seconds | 21.4 | |
| | 1.5% NOR 116 | | | | | | | |
| 2-K | 6.2% Exolit 760 | 6.2 | Black | Some char | Not stable | <25 seconds | 21.6 | |
| 2-L | 6.2% Exolit 760 plus | 7.7 | Black | Some char | Not stable | <25 seconds | 22.7 | |
| | 1.5% NOR 116 | | | | | | | |

| | | | | | | | |
|---|---|---|---|---|---|---|---|
| | FRI * | Smoke | Char | Char | | | |
| Product Version | (%) | Amount | Formation | Stability | Burn Duration | LOI | Other Comments |

Series 3 - extruded rod of 0.2 inch diameter and 6 inch length

| | | | | | | | | |
|---|---|---|---|---|---|---|---|---|
| 3-A | 14% Exolit 760 | 14 | Black | Some char | Stable | <20 seconds | 24 | Better char formation |
| 3-B | 17% Exolit 760 | 17 | Black | Some char | Stable | <20 seconds | 25 | Much improved char |
| 3-C | 20% Exolit 760 | 20 | Black | Some char | Stable | <15 seconds | 26 | Excellent result |
| 3-D | 14% Exolit 760 plus | 15.2 | Black | Some char | Stable | <15 seconds | 28 | Good result |
| | NOR 116 at 1.2% | | | | | | | |

Series 4 - extruded film strips of 1.5 inch width, 5 inch length and 0.007 inch thick and braided

| | | | | | | | | |
|---|---|---|---|---|---|---|---|---|
| 4-A | 16% Exolit 760 | 17.6 | Black | Some char | Stable | <15 seconds | 26+ | Good result |
| | plus 1.6% NOR 116 | | | | | | | |
| 4-B | 16% Exolit 760 | 17.6 | Black | Some char | Stable | <15 seconds | 26+ | Good result |
| | plus 1.6% NOR 116 | | | | | | | |
| 4-C | 16% Exolit 760 | 17.6 | Black | Some char | Stable | <15 seconds | 26+ | Good result |
| | plus 1.6% NOR 116 | | | | | | | |

Superbulk - FR Foamed Polypropylene Fibrillated tape available from Web Industries, Marlborough, MA.
NOR 116 - Hindered amine available from Ciba Geigy
Exolit 760 - ammonium polyphosphate from Clariant, Charlotte, North Carolina
* FRI - total flame retardant active ingredients (wt %)

### Example 2

Based on the findings of their efforts in Example 1, Applicants then endeavored to prepare fibrillated foamed cable filler strips of generally 1.5 inch width, 5 inch length and 0.007 inch thickness from select materials from Table 2. The formulations, all polypropylene based, and the results are presented in Table 3.

TABLE 3

| | | | Water | | Filler | | |
|---|---|---|---|---|---|---|---|
| | Product | Process- | Carry | | Softness/ | Winding | |
| | Version | ability | Over | Fibrillation | Flexibility | Difficulty | Other Comments |
| A | Superbulk ® FR | Yes | No | Yes | Acceptable | No | Commercial Cable Filler |
| | PP Cable filler | | | | | difficulties | w/halogenated FR |
| B | Clariant Exolit | no | Yes - | n/a | n/a | n/a | No good way to control |
| | 760 at 30% | | significant | | | | powder addition. |
| | | | | | | | Thermal degradation |
| | | | | | | | noted by color change. |
| | | | | | | | Poor control of foaming. |
| C | Ciba NOR 116 at | difficult | None | n/a | n/a | n/a | LOI < 24. Did not run |
| | 1% & 2% | | noted | | | | product through fibrillation |
| D | Ciba NOR 116 at | difficult | Significant | n/a | n/a | n/a | LOI < 24. Did not fibrillate |
| | 1.5% and Ciba | | when Exolit | | | | |
| | Exolit 760 | | was +25% | | | | |
| | at 20%-50% | | | | | | |
| E | Compounded | Yes - | Some | Yes | 20% Exolit | 20% Exolit | Must keep extruder |
| | NOR 116 at 1.6% | needed | noted at | | was more | did not wind | temperatures low and |
| | and compounded | to reduce | 20% Exolit | | brittle | as well as | reduce CFA by 50% to 60%. |
| | Exolit 760 at | CFA | | | | other | |
| | 12%, 16% & 20% | | | | | versions | |
| F | Compounded | Yes | Controlled | Yes | Acceptable | None | Must keep extruder |
| | NOR 116 at 1.6% | | | | | noted | temperatures low and |
| | and Exolit | | | | | | reduce CFA by 50% to 60%. |
| | 760 at 16% | | | | | | |
| G | Compounded | Yes | None | Yes | Acceptable | None | Met manufacturing |
| | NOR 116 at | | noted | | | noted | objectives |
| | 1.6% and Exolit | | | | | | |
| | 760 at 16% | | | | | | |
| H | Compounded | Yes | None | Yes | Acceptable | None | Repeated success in |
| | NOR 116 at | | noted | | | noted | achieving manufacturing |
| | 1.6% and Exolit | | | | | | objectives. Excellent |
| | 760 at 16% | | | | | | product uniformity and yield. |

As evident from Table 3 above, the use of 30% and more of the phosphorous based flame retardant additive resulted in extreme difficulty in processing as well as high water carry over. Thus, in the absence of improved processing capabilities and lower hydroscopic/hydrophilic properties, the amount of this additive should be less than 30 wt %. Additionally, in preparing the compositions of sample F, it was found that as one increased the amount of the phosphorous additive, a marked increase in foaming and hence density reduction, resulted. While it is desirable to have a high density reduction, too high and the material becomes difficult, if not impossible, to further process such as winding, slitting, etc. In these examples, the amount of foaming agent was reduced by 50 to 60% from those amounts typical for such polymers (and/or as instructed by the suppliers). Of course this result may vary from one foaming agent to another and from one cable forming composition to another; but, generally speaking, it was surprisingly found that one could use less foaming agents than would otherwise have been thought necessary or conventional in the absence of the claimed flame retardant agents.

Additionally, because of the temperature sensitivity of the phosphorous flame retardant additives, as well as the chemical foaming agents, it is desirable to keep the processing temperatures, particularly the extruder temperatures, low to avoid degradation of the flame retardant additive and to ensure a more uniform foam formation. Generally, it is preferable to employ extruder temperatures on the lower end of those appropriate for the melt formation and extrusion of the selected polyolefin. Such details can readily be ascertained from the manufacturer's processing guidelines for both the polyolefins, the foaming agent and, in particular, the flame retardant additive(s), or may be readily found by simple experimentation.

While the present teaching has been described with respect to aforementioned specific embodiments and examples, it should be appreciated that other embodiments utilizing the concept of the present teaching are possible without departing from the scope of the teaching. The present teaching is defined by the claimed elements and any and all modifications, variations, or equivalents that fall within the spirit and scope of the underlying principles embraced or embodied thereby.

I claim:

1. A fiber optic or electrically conductive cable comprising one or more coated wires or fiber optic filaments, a flame retardant cable filler in the form of a continuous yarn, fiber, filament, web, strip, tape or rod and formed of a polyolefin composition having incorporated therein from about 0.5 to 5 percent by weight of at least one halogen free NOR hindered amine flame retardant, at least one NOROL hindered amine flame retardant or a combination thereof, based on the combined weight of the hindered amine flame retardant and the polyolefin, and a sheath encasing the foregoing.

2. The cable of claim 1 wherein the flame retardant cable filler material is intertwined with one or more internal structural components of the cable.

3. The cable of claim 1 wherein the hindered amine corresponds to the general formula: 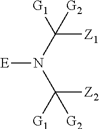
wherein
G₁ and G₂ are independently alkyl of 1 to 8 carbon atoms or are together pentamethylene,
Z₁ and Z₂ are each methyl, or Z₁ and Z₂ together form a linking moiety which may additionally be substituted by an ester, ether, amide, amino, carboxy or urethane group, and
E is oxyl, hydroxyl, alkoxy, cycloalkoxy, aralkoxy, ary, oxy, —O—CO—O Z₃, —O—Si(Z₄)₃, —O—PO(O Z₅)₂ or —O—CH₂—OZ where Z₃, Z₄, Z₅ and Z are selected from the group consisting of hydrogen, an aliphatic, araliphatic and aromatic moiety:
or E is —O-T-(OH)_{b} wherein
T is a straight or branched chain alkylene of 1 to 18 carbon atoms, cycloalkylene of 5 to 18 carbon atoms, cycloalkenylene of 5 to 18 carbon atoms, a straight or branched chain alkylene of 1 to 4 carbon atoms substituted by phenyl or by phenyl substituted by one or two alkyl groups of 1 to 4 carbon atoms and
b is 1, 2 or 3 with the proviso that b cannot exceed the number of carbon atoms in T, and when b is 2 or 3, each hydroxyl group is attached to a different carbon atoms of T.

4. The cable of claim 1 wherein the hindered amine flame retardant is present in an amount of from about 1 to about 2.5 weight percent based on the combined weight of the flame retardant and the polyolefin.

5. The cable of claim 1 wherein the polyolefin consists essentially of a homopolymer or copolymer of wholly olefin monomers or a blend of homo- and/or co-polyolefins comprised of wholly olefin monomers.

6. The cable of claim 1 wherein the polyolefin is selected from polyethylene, polypropylene, ethylene-propylene copolymer, polyethylene-polypropylene blends, and thermoplastic olefin polymer (TPO).

7. The cable of claim 1 wherein the polyolefin is a foamed polyolefin.

8. The cable of claim 7 wherein the foamed polyolefin has a density reduction of from about 20% to 60%.

9. The cable of claim 7 wherein the polyolefin cable filler is fibrillated.

10. The cable of claim 1 wherein the polyolefin cable filler is fibrillated.

11. The cable of claim 1 wherein the cable filler is in the form of a yam or a web material rolled into a cylinder shape having a denier of from 800 to 50,000.

12. The cable of claim 1 wherein the cable filler is in the form of a fiber, filament or rod having a diameter of 0.01 to 0.2 inches.

13. The cable of claim 1 wherein the cable filler is in the form of a strip or ape having a thickness of 0.5 to 20 mils.

14. The cable of claim 1 wherein the polyolefin further includes a halogen free phosphorous based flame retardant additive.

15. The cable of claim 14 wherein the halogen-free phosphorous based flame retardant additive is selected from tetraphenyl resorcinol diphosphite, triphenyl phosphate, trioctyl phosphate, tricresyl phosphate, tetrakis(hydroxymethyl)-phosphonium sulfide, diethyl-N,N-bis-2-hydroxyethyl)-aminomethyl phosphonate, hydroxyalkyl esters of phosphorous acids, ammonium polyphosphate (APP), resorcinol diphosphate oligomers (RDP), phosphazene flame retardants and ethylenediamine diphosphate (EDAP).

16. A fiber optic or electrically conductive cable comprising one or more coated wires or fiber optic filaments; a foamed, fibrillated or foamed and fibrillated polypropylene flame retardant cable filler in the form of a continuous yarn, web, strip, or tape or rod and formed of a polyolefin composition having incorporated therein from about 0.5 to 5 percent by weight of at least one halogen free NOR hindered amine flame retardant, at least one NOROL hindered amine flame retardant or a combination thereof, based on the combined weight of the hindered amine flame retardant and the polyolefin; and a sheath encasing the foregoing.

17. The cable of claim 16 wherein the flame retardant cable filler material is intertwined with one or more internal structural components of the cable.

18. The cable of claim 16 wherein the hindered amine corresponds to the general formula: 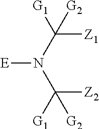
wherein
G₁ and G₂ are independently alkyl of 1 to 8 carbon atoms or are together pentamethylene,
Z₁ and Z₂ are each methyl, or Z₁ and Z₂ together form a linking moiety which may additionally be substituted by an ester, ether, amide, amino, carboxy or urethane group, and
E is oxyl, hydroxyl, alkoxy, cycloalkoxy, aralkoxy, aryloxy, —O—CO—O Z₃, —O—Si(Z₄)₃, —O—PO(O Z₅)₂ or —O—CH₂—OZ where Z₃, Z₄, Z₅ and Z are selected from the group consisting of hydrogen, an aliphatic, araliphatic and aromatic moiety;
or E is —O-T-(OH)_{b} wherein
T is a straight or branched chain alkylene of 1 to 18 carbon atoms, cycloalkylene of 5 to 18 carbon atoms, cycloalkenylene of 5 to 18 carbon atoms, a straight or branched chain alkylene of 1 to 4 carbon atoms substituted by phenyl or by phenyl substituted by one or two alkyl groups of 1 to 4 carbon atoms and
b is 1, 2 or 3 with the proviso that b cannot exceed the number of carbon atoms in T, and when b is 2 or 3, each hydroxyl group is attached to a different carbon atoms of T.

19. The cable of claim 16 wherein the cable filler is fibrillated.

20. The cable of claim 16 wherein the polyolefin further includes a halogen-free phosphorous based flame retardant additive.
